(19) United States
(12) Patent Application Publication
(10) Pub. No.: US 2026/0219749 A1
(43) Pub. Date: Jul. 30, 2026

(54) WEARABLE ELECTRONIC DEVICE FOR CONTROLLING OPERATION OF ELECTRONIC DEVICE, OPERATION METHOD THEREOF, AND STORAGE MEDIUM

(71) Applicant: SAMSUNG ELECTRONICS CO., LTD., Suwon-si (KR)

(72) Inventors: Hyekyung JEON, Suwon-si (KR); Hongki KIM, Suwon-si (KR); Youngjin OH, Suwon-si (KR); Taehyun WOO, Suwon-si (KR)

(73) Assignee: SAMSUNG ELECTRONICS CO., LTD., Suwon-si (KR)

(21) Appl. No.: 19/578,211

(22) Filed: Mar. 25, 2026

Related U.S. Application Data
(63) Continuation of application No. PCT/KR2024/012565, filed on Aug. 22, 2024.

(30) Foreign Application Priority Data
Sep. 27, 2023 (KR) 10-2023-0130874
Oct. 25, 2023 (KR) 10-2023-0143916

(51) Int. Cl. G06F 3/041; G06F 1/16; G06F 3/01

(52) U.S. Cl. CPC G06F 3/041; G06F 1/163; G06F 3/017

(57) ABSTRACT

A wearable electronic device having a ring-shape includes at least one first sensor configured to detect a touch input on the wearable electronic device; at least one second sensor configured to detect a movement of the wearable electronic device; communication circuitry; memory storing instructions; and at least one processor coupled to the at least one first sensor, the at least one second sensor, the communication circuitry, and the memory. The instructions, when executed by the at least one processor individually or collectively, cause the wearable electronic device to detect the touch input using the at least one first sensor; based on detecting the touch input, detect a signal representing a gesture using the at least one second sensor; and transmit information representing the gesture to an electronic device connected to the wearable electronic device using the communication circuitry.

### CROSS-REFERENCE TO RELATED APPLICATIONS

This application is a bypass continuation application of International Patent Application No. PCT/KR2024/012565, filed on August 22, 2024, which claims priority to and is based on Korean Patent Application No. 10-2023-0130874, filed on September 27, 2023, and Korean Patent Application No. 10-2023-0143916, filed on October 25, 2023, in the Korean Ministry of Intellectual Property, the disclosures of which are incorporated by reference herein in their entireties.

### BACKGROUND

### 1. Field

The disclosure relates to a wearable electronic device for controlling an operation of an electronic device, an operating method thereof, and a storage medium.

### 2. Description of Related Art

Wearable electronic devices may be downsized or made lightweight to the extent that they may be used without significant inconvenience even when worn on a user’s body. For example, wearable electronic devices such as a head mounting display device (HMD) device, a smart watch (or band), a contact lens-type device, a ring-type device, a glove-type device, a shoe-type device, or a clothing-type device may be worn directly on the body to enhance portability and user accessibility.

In the development of the wearable electronic device, ease of use of the wearable electronic device may be important along with the external design of the wearable electronic device.

As an example, in the case of a ring-shaped wearable electronic device wearable on a user’s finger, since the size thereof is small, it may be worn at all times, and various services for managing a user’s health or identifying health status through measurement of various biometric signals may be provided. However, as devices become wearable, their applications beyond monitoring methods can be improved.

The above-described information may be provided as related art for the purpose of helping understanding of the disclosure. No claim or determination is made as to whether any of the foregoing is applicable as background art in relation to the disclosure.

### SUMMARY

According to an aspect of the disclosure, a wearable electronic device having a ring-shape, includes: at least one first sensor configured to detect a touch input on the wearable electronic device; at least one second sensor configured to detect a movement of the wearable electronic device; communication circuitry; memory storing instructions; and at least one processor coupled to the at least one first sensor, the at least one second sensor, the communication circuitry, and the memory. The instructions, when executed by the at least one processor individually or collectively, may cause the wearable electronic device to detect the touch input using the at least one first sensor; based on detecting the touch input, detect a signal representing a gesture using the at least one second sensor; and transmit information representing the gesture to an electronic device connected to the wearable electronic device using the communication circuitry.

The instructions, when executed by the at least one processor individually or collectively, may further cause the wearable electronic device to, based on detecting the touch input, identify whether a position where the touch input is detected is within a specified range from a reference position; and based on identifying that the position where the touch input is detected is within the specified range, detect the signal representing the gesture using the at least one second sensor.

The instructions, when executed by the at least one processor individually or collectively, may further cause the wearable electronic device to, based on identifying that the position where the touch input is detected is outside the specified range, output a notification guiding an adjustment of a wearing position of the wearable electronic device.

The instructions, when executed by the at least one processor individually or collectively, may further cause the wearable electronic device to, based on identifying that the position where the touch input is detected is within the specified range, output a notification guiding initiation of a gesture function of the wearable electronic device.

The instructions, when executed by the at least one processor individually or collectively, may further cause the wearable electronic device to, based on the signal representing the gesture, identify a command for controlling an operation of the electronic device; and transmit the command for controlling the operation of the electronic device to the electronic device using the communication circuitry.

The instructions, when executed by the at least one processor individually or collectively, may further cause the wearable electronic device to, based on detecting the touch input, identify whether the touch input within a specified range from a reference position is maintained for a predetermined time; based on identifying that the touch input within the specified range is maintained for the predetermined time, detect the signal representing the gesture using the at least one second sensor; and based on identifying that the touch input within the specified range is maintained for the predetermined time after transmitting the information representing the gesture, terminate an operation of detecting the signal representing the gesture.

The at least one first sensor may include a first part and a second part spaced apart from the first part by a predetermined distance. The fingers on both sides of a first finger of a user may come into contact with the first part and the second part based on the wearable electronic device being worn on the first finger. The instructions, when executed by the at least one processor individually or collectively, may further cause the wearable electronic device to, detect a combination of touch inputs using the first part and the second part of the at least one first sensor; and based on detecting the combination of touch inputs, detect the signal representing the gesture using the at least one second sensor.

The at least one first sensor may include sensing circuitry connected to the first part and the second part of the at least one first sensor.

According to an aspect of the disclosure, a method for controlling an operation of an electronic device from a wearable electronic device having a ring-shape, includes: detecting a touch input on the wearable electronic device using at least one first sensor; based on detecting the touch input, detecting a signal representing a gesture using at least one second sensor configured to detect a movement of the wearable electronic device; and transmitting information representing the gesture to the electronic device.

The detecting the signal representing the gesture may include, based on detecting the touch input, identifying whether a position where the touch input is detected is within a specified range from a reference position; and based on identifying that the position where the touch input is detected is within the specified range, detecting the signal representing the gesture.

The method may further include, based on identifying that the position where the touch input is detected is outside the specified range, outputting a notification guiding an adjustment of a wearing position of the wearable electronic device.

The method may further include, based on identifying that the position where the touch input is detected is within the specific range, outputting a notification guiding initiation of a gesture function of the wearable electronic device.

The method may further include, based on the signal representing the gesture, identifying a command for controlling the operation of the electronic device; and transmitting the command for controlling the operation of the electronic device to the electronic device.

According to an aspect of one or more embodiments of the present disclosure, a non-transitory computer-readable storage medium stores instructions that, when executed by at least one processor of a wearable electronic device, cause the wearable electronic device to detect a touch input on the wearable electronic device using at least one first sensor; based on detecting the touch input, detect a signal representing a gesture using at least one second sensor configured to detect a movement of the wearable electronic device; and transmit information representing the gesture to an electronic device connected to the wearable electronic device.

The instructions, when executed by the at least one processor of the display device, may further cause the wearable electronic device to, based on detecting the touch input, identify whether a position where the touch input is detected is within a specified range from a reference position; and based on identifying that the position where the touch input is detected is within the specified range, detect the signal representing the gesture using the at least one second sensor.

The instructions, when executed by the at least one processor of the display device, may further cause the wearable electronic device to, based on identifying that the position where the touch input is detected is outside the specified range, output a notification guiding an adjustment of a wearing position of the wearable electronic device.

The instructions, when executed by the at least one processor of the display device, may further cause the wearable electronic device to, based on identifying that the position where the touch input is detected is within the specified range, output a notification guiding initiation of a gesture function of the wearable electronic device.

The instructions, when executed by the at least one processor of the display device, may further cause the wearable electronic device to, based on the signal representing the gesture, identify a command for controlling an operation of the electronic device; and transmit the command for controlling the operation of the electronic device to the electronic device using the communication circuitry.

The instructions, when executed by the at least one processor of the display device, may further cause the wearable electronic device to, based on detecting the touch input, identify whether the touch input within a specified range from a reference position is maintained for a predetermined time; based on identifying that the touch input within the specified range is maintained for the predetermined time, detect the signal representing the gesture using the at least one second sensor; and based on identifying that the touch input within the specified range is maintained for the predetermined time after transmitting the information representing the gesture, terminate an operation of detecting the signal representing the gesture.

According to one or more embodiments, the at least one operation may include transmitting information representing the gesture to an electronic device communicatively connected to the wearable electronic device.

### BRIEF DESCRIPTION OF DRAWINGS

The above and other aspects, features, and advantages of one or more embodiments of the present disclosure will be more apparent from the following description taken in conjunction with the accompanying drawings, in which:

FIG. 1 is a block diagram illustrating an electronic device in a network environment according to one or more embodiments;

FIG. 2 is a view illustrating usage examples of a wearable electronic device according to one or more embodiments;

FIG. 3 is a perspective view illustrating a wearable electronic device according to one or more embodiments;

FIG. 4 is a cross-sectional view illustrating a wearable electronic device according to one or more embodiments;

FIG. 5A is an internal block configuration diagram illustrating a wearable electronic device according to one or more embodiments;

FIG. 5B is a detailed block configuration diagram for user customization according to one or more embodiments;

FIG. 6 is an operation flowchart for controlling an operation of an electronic device in a wearable electronic device according to one or more embodiments;

FIG. 7 is a detailed operation flowchart for controlling an operation of an electronic device using a gesture by a wearable electronic device according to one or more embodiments;

FIG. 8A is a view illustrating a wearing example of a wearable electronic device corresponding to a first gesture according to one or more embodiments;

FIG. 8B is a view illustrating a sensor arrangement for detecting a first gesture in a wearable electronic device according to one or more embodiments;

FIG. 9A is a view illustrating a wearing example of a wearable electronic device corresponding to a second gesture according to one or more embodiments;

FIG. 9B is a view illustrating a sensor arrangement for detecting a second gesture in a wearable electronic device according to one or more embodiments;

FIG. 10 is a view illustrating a third gesture of a wearable electronic device for controlling an operation of an electronic device according to one or more embodiments;

FIG. 11 is a view illustrating a fourth gesture of a wearable electronic device for controlling an operation of an electronic device according to one or more embodiments; and

FIG. 12 is a view illustrating a fifth gesture of a wearable electronic device for controlling an operation of an electronic device according to one or more embodiments.

### DETAILED DESCRIPTION

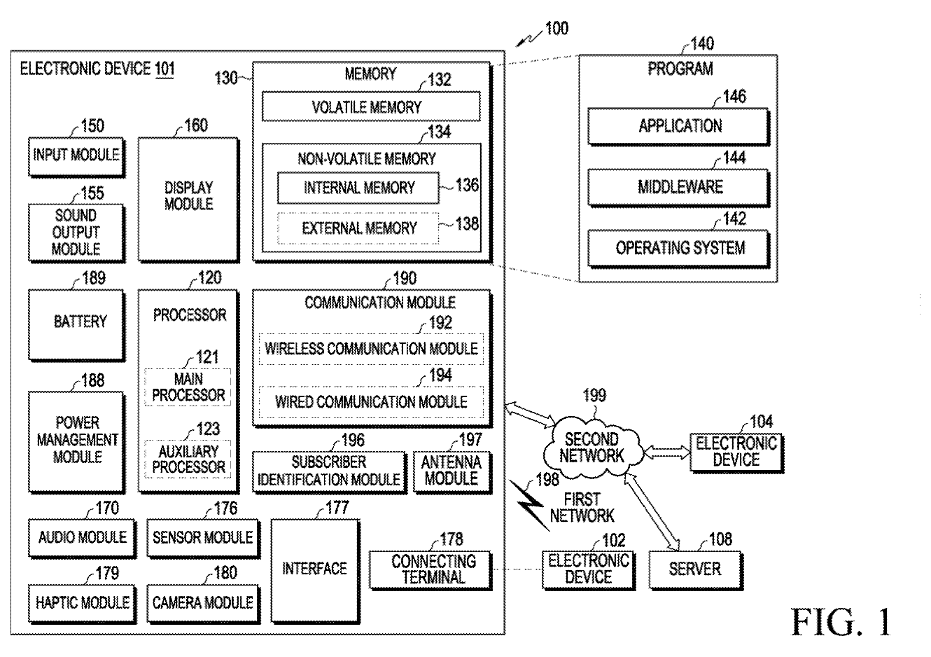

FIG. 1 is a block diagram illustrating an electronic device 101 in a network environment 100 according to various embodiments. Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an external environmental state (e.g., the user’s state), and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wiredly) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wiredly) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth^{TM}, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing eMBB, loss coverage (e.g., 164dB or less) for implementing mMTC, or U-plane latency (e.g., 0.5ms or less for each of downlink (DL) and uplink (UL), or a round trip of 1ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

In the following description, the components easy to understand from the description of the above embodiments are denoted with or without the same reference numerals and their detailed description may be skipped. According to one or more embodiments of the disclosure, an electronic device may be implemented by selectively combining configurations of different embodiments, and the configuration of one embodiment may be replaced by the configuration of another embodiment. However, it is noted that embodiments of the disclosure are not limited to a specific drawing or embodiment.

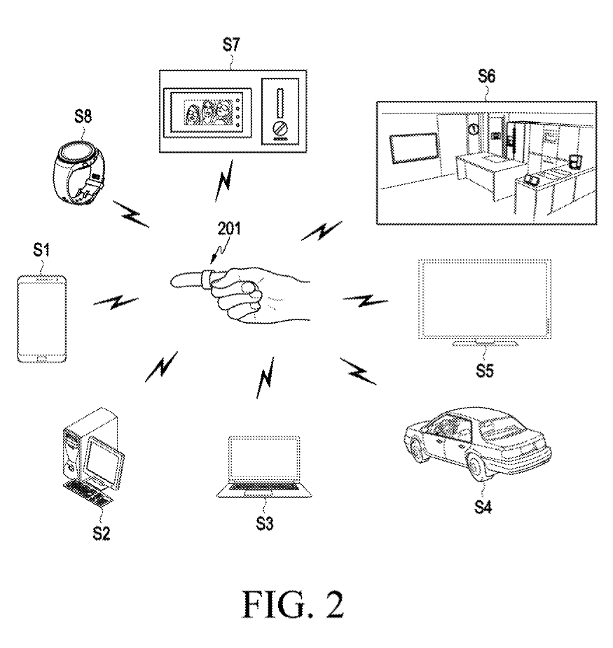

FIG. 2 is a view illustrating usage examples of a wearable electronic device according to one or more embodiments.

Referring to FIG. 2, a wearable electronic device 201 (e.g., the electronic device 101 of FIG. 1) may be configured to be wearable on the user’s body. For example, the wearable electronic device 201 may be implemented as a wearable electronic device wearable on the user’s finger. For example, the wearable electronic device 201 may be provided in the form of a ring that may be worn on the user’s finger. For example, the wearable electronic device 201 may be referred to as a smart ring.

According to one or more embodiments, the wearable electronic device 201 may perform wireless communication with another electronic device (e.g., the electronic device 102 or 104 of FIG. 1) through a wireless communication network (e.g., the first network 198 or the second network 199 of FIG. 1).

For example, the wearable electronic device 201 may perform wireless communication with another electronic device such as a smart phone S1, desktop/laptop computers S2 and S3, a car S4, a smart TV S5, indoor smart home devices S6, a tablet PC S7, or a smart watch S8. Wireless communication between the wearable electronic device 201 and another electronic device may be implemented as wireless communication such as a short-range communication network (e.g., the first network 198 of FIG. 1) or a long-range communication network (e.g., the second network 199 of FIG. 1). For example, when a Bluetooth communication link is established between the wearable electronic device 201 and an electronic device that a user wishes to access, transmission of a message between the two electronic devices may be possible. Further, the wearable electronic device 201 worn by the user may generate a command corresponding to each specific movement/gesture of the user’s finger and transmit the command to another electronic device.

According to one or more embodiments, in order to detect the user’s finger movement/gesture, motion sensors (e.g., the sensor module 176 of FIG. 1) such as an accelerometer, a gyroscope, or an electronic compass may be disposed in the wearable electronic device 201. When a message is received from another electronic device to the electronic device 201, the electronic device 201 may notify the user of message reception using sound, vibration, a display screen, or lighting (e.g., a light emitting diode (LED), or a xenon lamp). To that end, the wearable electronic device 201 may include a sound module (e.g., the sound output module 155 or the audio module 170 of FIG. 1), a haptic module (e.g., the haptic module 179 of FIG. 1), or a display module (e.g., the display module 160 of FIG. 1). According to one or more embodiments, in the wearable electronic device 201, at least one of the sound module, the haptic module, or the display module may be omitted. Further, the wearable electronic device 201 may obtain biometric information (e.g., oxygen saturation) of the user and provide the biometric information to the other electronic device.

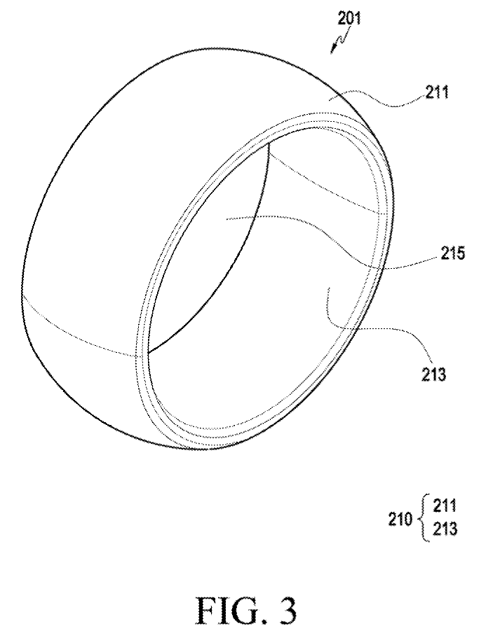

FIG. 3 is a perspective view illustrating a wearable electronic device according to one or more embodiments.

Referring to FIG. 3, a wearable electronic device 201 may include a housing 210. The housing 210 may form the overall appearance of the wearable electronic device 201.

According to one or more embodiments, the housing 210 may have a ring shape. The housing 210 may include an opening 215 configured to receive a user’s finger. For example, the opening may be defined as a hole formed in the housing 210.

According to one or more embodiments, the housing 210 may include an outer housing portion 211 or an inner housing portion 213. For example, the inner housing portion 213 may be coupled to the outer housing portion 211. According to one or more embodiments, the outer housing portion 211 and the inner housing portion 213 may be separately manufactured and assembled, or may be integrally formed.

According to one or more embodiments, the outer housing portion 211 may include a material capable of withstanding external shocks and/or scratches and implementing design features. For example, the outer housing portion 211 may include titanium, stainless steel, or ceramic. For example, the outer housing portion 211 may be color-treated or coated for design implementation.

According to one or more embodiments, the inner housing portion 213 may include a portion that contacts the user’s finger when the user wear the wearable electronic device 201. For example, the inner housing portion 213 may include a material such as a molding material for sensing, transparent plastic, or glass. For example, the inner housing portion 213 may be implemented at least partially transparently. For example, the inner housing portion 213 may include a material capable of transmitting light for measuring biometric information. At least a portion of the inner housing portion 213 may be formed of a material substantially the same as or similar to that of the outer housing portion 211. Further, at least a portion of the inner housing portion 213 may include a metal material for measuring biometric information.

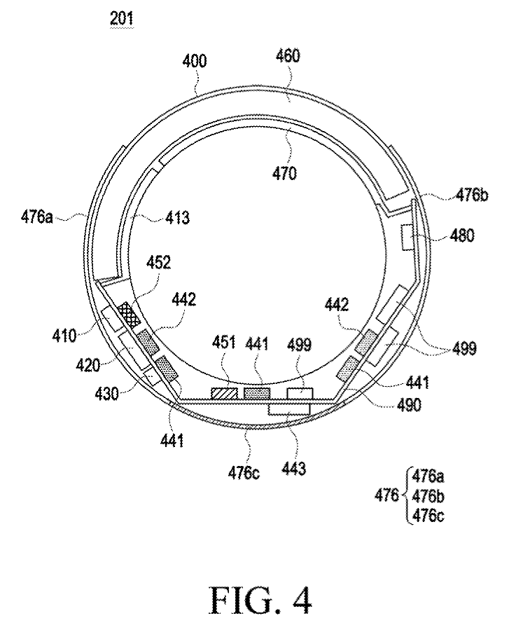

According to one or more embodiments, the outer housing portion 211 and the inner housing portion 213 may be coupled to provide an inner space of the housing 210. Various electrical/electronic components of the wearable electronic device 201 may be disposed and/or included in the inner space of the housing 210. For example, the housing 210 may accommodate various electrical/electronic components. FIG. 4 may be referred to for a detailed illustration of the inner space of the housing 210.

FIG. 4 is a cross-sectional view illustrating a wearable electronic device according to one or more embodiments.

The arrangement of components of the wearable electronic device 201 of FIG. 4 is merely an example. The components of the wearable electronic device 201 may be disposed differently from FIG. 4.

According to one or more embodiments, the wearable electronic device 201 may include a housing 400 (e.g., the housing 210 of FIG. 3).

According to one or more embodiments, the wearable electronic device 201 may include a processor 420. For example, the processor 420 may be an MCU (micro controller unit). Further, the processor 420 may be an AP (application processor), an SP (supplementary processor (e.g., sensor hub)), a CPU (central processor unit), an NPU (neural processor unit), a GPU (graphic processor unit), or an IoT (internet of things) processor.

According to one or more embodiments, the wearable electronic device 201 may include a communication module 410.

According to one or more embodiments, the wearable electronic device 201 may include an antenna 413. The antenna 413 may be an antenna for wireless communication. For example, the antenna 413 may include a single or a plurality of segmented antennas. Referring to FIG. 4, a portion of the housing 400 of the wearable electronic device 201 may be utilized as a radiator of the antenna 413.

According to one or more embodiments, the wearable electronic device 201 may include memory 430. Referring to FIG. 4, the wearable electronic device 201 may store data (e.g., sensing data or communication data) in the memory 430. For example, the memory 430 may be in an integrated form with the processor 420.

According to one or more embodiments, the wearable electronic device 201 may include a photoplethysmography (PPG) sensor 441, 442, 443. The PPG sensor 441, 442, 443 may be a sensor that radiates light onto a living body and receives light that is absorbed, scattered, or reflected. The wearable electronic device 201 may identify a biometric signal by using the PPG sensor 441, 442, 443. Referring to FIG. 4, at least one light emitting portion 441 of the PPG sensor may emit light of various bands and may include an element such as a light emitting diode (LED), a laser, or a vertical cavity surface emitting laser (VCSEL). For example, the band of the light emitting portion 441 may include green, red, or infrared (IR). At least one light receiving portion 442 of the PPG sensor may receive light reflected and/or transmitted from the light radiated from the light emitting portion 441. A signal (e.g., light) obtained through the light receiving portion 442 may be converted through an analog to digital converter (ADC) and stored in the memory 430 or a sensor buffer. For example, the light receiving portion 442 may include a photodiode (PD) or a complementary metal oxide semiconductor (CMOS). The controller 443 of the PPG sensor may be an integrated circuit (IC) or an analog front end (AFE), and may control the light emitting portion 441 and the light receiving portion 442, process received data, and transmit the data to the processor 420 or store the data in the memory 430.

According to one or more embodiments, the wearable electronic device 201 may include an inertial sensor 451. For example, the inertial sensor 451 may be a sensor that senses inertia, such as an accelerometer or a gyroscope. Referring to FIG. 4, the inertial sensor 451 may include only an accelerometer (e.g., a 3-axis sensor), or may include an accelerometer and a gyroscope (e.g., a 6-axis sensor). By using the inertial sensor 451, the wearable electronic device 201 may detect (or sense) a gesture, motion, impact, posture, or activity (sedentary, moving, sports) of the wearable electronic device 201.

According to one or more embodiments, the wearable electronic device 201 may include a temperature sensor 452. The temperature sensor 452 may be a sensor that measures a temperature of a living body or a component. The temperature sensor 452 may be a contact type or a non-contact type according to the method. The temperature value measured through the temperature sensor 452 may be stored in the memory 430 or may be transferred to the processor 420. The wearable electronic device 201 (e.g., the controller 313) may estimate the temperature of a living body, estimate the temperature of the wearable electronic device 201, or recognize a circumstance around the wearable electronic device 201 by using the temperature sensor 452.

According to one or more embodiments, the wearable electronic device 201 may include a battery 460. The battery 460 may be a device that converts and stores chemical energy into electricity to supply power to the wearable electronic device 201. The battery 460 (e.g., a secondary battery) is charged and discharged, and may be variously implemented according to the material, such as lithium ion or mercury. Referring to FIG. 4, the battery 460 may include a bendable battery pack to correspond to the housing 400. For example, the battery 460 may include a plurality of non-bendable battery packs. The battery 460 may include, e.g., a bendable battery pack and a non-bendable battery pack.

According to one or more embodiments, the wearable electronic device 201 may include a charging circuit 470. The charging circuit 470 may be configured to support a wired charging (e.g., a terminal or a pogo pin) and/or a wireless charging (e.g., WPC or NFC) method for charging the wearable electronic device 201 (e.g., the battery 460). The wearable electronic device 201 may charge the battery 460 through the charging circuit 470.

According to one or more embodiments, the wearable electronic device 201 may include a power management module 480. The power management module 480 may be a module that manages power of the wearable electronic device 201. The wearable electronic device 201 (e.g., the controller 313) may distribute and control power to the processor 420 and the sensor 441, 442, 443, 451, 452 through the power management module 480.

According to one or more embodiments, the wearable electronic device 201 may include a substrate 490. For example, the substrate 490 may be a flexible printed circuit board (FPCB). Referring to FIG. 4, various components such as the communication module 410, the processor 420, the memory 430, the sensor 441, 442, 443, 451, 452, the battery 460, or the power management module 480 may be disposed on the substrate 490. The various components disposed on the substrate 490 may be electrically connected.

According to one or more embodiments, the wearable electronic device 201 may include a sensor module 476. According to one or more embodiments, the sensor module 476 may include a touch circuit, and the touch circuit may include a touch sensor and a touch sensor IC for controlling the same. The touch sensor IC may, e.g., control the touch sensor to detect a touch input to a specific location on a surface of an outer housing (e.g., the outer housing portion 211 of FIG. 3). For example, the touch sensor IC may detect the touch input by measuring a change in a signal (e.g., voltage, amount of light, resistance, or amount of charge) at the specific location on the surface. The touch sensor IC may provide information (e.g., location, area, pressure, or time) related to the detected touch input to the processor 420.

According to one or more embodiments, the sensor module 476 may further include a pressure sensor capable of measuring a touch intensity (e.g., pressure).

According to one or more embodiments, at least a portion of the housing 400 (e.g., the outer housing 211 of FIG. 2) of the wearable electronic device 201 may include a display module. For example, when the wearable electronic device 201 includes a display module, the display module may include a touch circuit. For example, the display module may further include at least one sensor (e.g., a pressure sensor) of the sensor module 476 or a control circuit therefor. In this case, the at least one sensor or the control circuit therefor may be embedded in a portion of the display module or a portion of the touch circuit. For example, when the sensor module 476 embedded in the display module includes a pressure sensor, the pressure sensor may obtain pressure information associated with a touch input through a partial or entire area of the housing 400 (or a display). According to one or more embodiments, the sensor module 476 including a touch sensor may be disposed between pixels of a pixel layer of a display, or above or below the pixel layer.

According to one or more embodiments, the sensor module 476 may detect a touch input to an entire area or a partial area of a curved outer housing of the outer housing.

According to one or more embodiments, the sensor module 476 may detect a touch input at a first portion (or first touch area) 476a of a curved outer housing and a second portion (or second touch area) 476b spaced apart from the first portion 476a by a predetermined distance. For example, the first portion 476a and the second portion 476b may correspond to a position where a finger adjacent to two opposite sides of the finger contacts, when the wearable electronic device 201 is worn on a user’s finger.

According to one or more embodiments, the sensor module 476 may include a third portion (or third touch area) 476c different from the first portion 476a and the second portion 476b. Further, a pressure sensor may be disposed in a partial area 476a, 476b, 476c to measure an intensity of force generated by the touch. According to one or more embodiments, the pressure sensor may include a plurality of pressure sensors. Further, the pressure sensor may be disposed at a predetermined interval along the curved shape of the housing to enable detection of pressure by a touch input to a specific location on an entire area or a partial area surface surrounding the outer housing.

According to one or more embodiments, the wearable electronic device 201 may include a sound output module, a haptic module, a light output module (e.g., a light emitting diode (LED)), or other components 499, which is described later.

The wearable electronic device 201 may detect a state of being worn on a finger using the sensor module 476 included in the wearable electronic device 201. According to one or more embodiments, the wearable electronic device 201 may generate a command corresponding to each specific movement/gesture of the user’s finger and transmit the command to a communicatively connected electronic device. The command may be used to control an operation of the electronic device.

User experience may be enhanced by identifying whether the user intended to control an operation of the electronic device based on a gesture when the user wears the wearable electronic device 201. Therefore, a process of determining whether to use a gesture function of the wearable electronic device 201 for controlling an operation of the electronic device may need to precede. Here, the gesture function may include not only a specific movement/gesture of a finger in a state in which a user’s finger wears the wearable electronic device 201, but also a movement of the wearable electronic device 201 itself or various touch inputs through the wearable electronic device 201.

One or more embodiments relate to a wearable electronic device, an operating method thereof, and a storage medium for enabling a gesture reflecting a user’s intention to be used for controlling an operation of an electronic device by identifying an activation timing of a gesture function of the wearable electronic device 201.

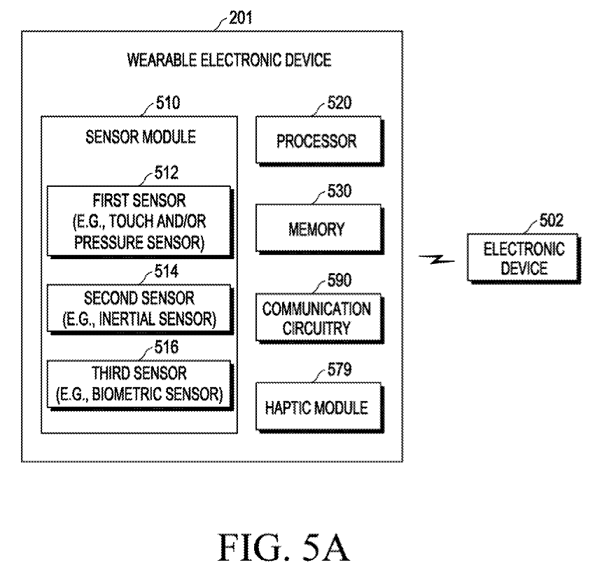

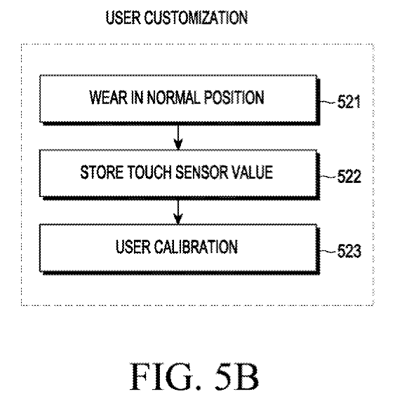

FIG. 5A is an internal block configuration diagram illustrating a wearable electronic device according to one or more embodiments. The wearable electronic device 201 of FIG. 5A may include the same or similar components as the electronic device 101 of FIG. 1. Further, the wearable electronic device 201 may have a ring-shape as in FIGS. 2 to 4.

Referring to FIG. 5A, the wearable electronic device 201 may include a sensor module 510 (e.g., the sensor module 176 of FIG. 1 or the sensor module 476 of FIG. 4), at least one processor 520 (e.g., the processor 120 of FIG. 1 or the processor 420 of FIG. 4), memory 530 (e.g., the memory 130 of FIG. 1), or communication circuitry 590 (e.g., the communication module 190 of FIG. 1 or the communication module 410 of FIG. 4). The wearable electronic device 201 may further include a haptic module 579 (e.g., the haptic module 179). According to one or more embodiments, the wearable electronic device 201 may omit at least one of the components or may additionally include other components.

According to one or more embodiments, the sensor module 510 may include at least one sensor such as a first sensor 512, a second sensor 514, or a third sensor 516. For example, the first sensor 512 may include a touch sensor and/or a pressure sensor for detecting a touch input or pressure by a touch input on the wearable electronic device 201.

The second sensor 514 may include at least one inertial sensor for detecting a movement of the wearable electronic device 201, and the at least one inertial sensor may be an accelerometer or a gyroscope. For example, the second sensor 514 may output sensor information (or sensor value) including movement, rotation, rotation angle, tilt, tilt direction, and/or posture of the wearable electronic device 201.

The third sensor 516 may include a biometric sensor for obtaining a biometric signal (or biometric information) of a user wearing the wearable electronic device 201.

According to one or more embodiments, activation of a gesture function for controlling an operation of an electronic device 502 communicatively connected to the wearable electronic device 201 may be triggered by a configured input method such as a touch input detected through a touch sensor or pressure detected through a pressure sensor. For example, the touch input may include, in addition to a user’s touch input to a specific location (or area) detected through a touch sensor, a touch pressure according to a user’s pressing pressure, a touch contact time (e.g., a long press), or a double touch input (e.g., contact by fingers on two opposite sides of the wearing finger). For example, the pressure may include an intensity, direction, duration, or amount of change of the pressure. In the following description, the wearable electronic device 201 and the operating method thereof according to one or more embodiments is described focusing on a touch input, but a person of ordinary skill in the art will understand that the embodiment is not limited thereto.

According to one or more embodiments, the processor 520 may control the overall operation of the wearable electronic device 201. For example, the processor 520 may be implemented identically or similarly to the processor 120 of FIG. 1 or the processor 420 of FIG. 4.

According to one or more embodiments, the processor 520 may form a communication connection to the electronic device 502 through the communication circuitry 590. For example, the communication circuitry 590 may support short-range communication technology (e.g., Bluetooth, Bluetooth low energy (BLE), or Wi-Fi). The communication connection may be formed using any one of the communication technologies supported by the communication circuitry 590.

According to one or more embodiments, the memory 530 may store instructions configured to detect a touch input through the first sensor 512, based on detecting the touch input, detect a signal representing a gesture using the second sensor 514, and transmit information representing the gesture to an electronic device 502 communicatively connected to the wearable electronic device 201 through the communication circuitry 590.

According to one or more embodiments, the processor 520 may identify a command for controlling an operation of the electronic device 502 based on the signal representing the gesture and transmit the command to the electronic device 502. According to one or more embodiments, the processor 520 may transmit information representing a gesture to the electronic device 502 to control an operation of the electronic device 502. For example, the electronic device 502 may control various operations such as quick execution of a specified function such as a camera function of the electronic device 502, financial payment, or volume adjustment, or control movement of a pointer according to the information representing the gesture or the command.

According to one or more embodiments, the processor 520 may determine an activation timing of the gesture function to determine whether to use the gesture function for controlling an operation of the electronic device 502.

According to one or more embodiments, the processor 520 may determine whether to activate the gesture function based on detection of a touch input through the first sensor 512. For example, the processor 520 may activate (or turn on) the gesture function when a position where a touch input is detected is within a specified range from a reference position. For example, the processor 520 may activate the gesture function when a touch input is detected (or received) for a predetermined time within the specified range from the reference position. In one or more embodiments, if a touch input is detected outside the specified range from the reference position, the processor 520 may output a notification guiding to adjust the wearing position. For example, the processor 520 may induce the user to adjust the wearing position by outputting a mechanical stimulus (e.g., vibration (feedback twice) or movement) through the haptic module 579. For example, the processor 520 may provide the notification guiding to adjust the wearing position to the electronic device 201 so that the notification is displayed through a display of the electronic device 201.

For example, assuming a case where the wearable electronic device 201 is divided into four portions by 90 degrees based on the central axis, when it is inserted in a rotated state on the user’s finger, a portion that contacts a finger adjacent to two opposite sides of the finger may be outside the specified range from a specific reference point or the reference position. For example, as the user adjusts the wearing position, the notification may be stopped as the detected touch input is detected within the specified range. For example, after outputting a notification guiding to adjust the wearing position, the processor 520 may continuously or repeatedly output the notification unless the touch input is detected within the specified range.

According to one or more embodiments, as the touch input is detected within the specified range for a predetermined time as the user adjusts the wearing position, the processor 520 may output a notification (e.g., vibration feedback once) guiding initiation of the gesture function of the wearable electronic device 201. For example, the notification guiding initiation of the gesture function may differ from the notification guiding to adjust the wearing position in an output method of the notification, such as a vibration pattern, vibration intensity, or number of vibrations.

According to one or more embodiments, the processor 520 may detect a signal representing a gesture through the second sensor 514 after activation of the gesture function. For example, the processor 520 may obtain gesture-related information based on sensing information sensed by the first sensor 512 as well as sensing information by the second sensor 514. For example, the processor 520 may transmit gesture-related information to the electronic device 502 to control an operation of the electronic device 502. In one or more embodiments, after transmitting information representing a gesture, if a touch input is detected again for a predetermined time within the specified range, since the touch input is a user input intended to terminate the gesture function, the processor 520 may terminate the operation of detecting a signal representing a gesture through the second sensor 514.

When wearing the wearable electronic device 201, the finger on which each user wears may be different, and the wearing method may also be different. Therefore, if a wearing state of the user may be distinguished, user customization may be possible. FIG. 5B may be referred to describe this. FIG. 5B is a detailed block configuration diagram for user customization according to one or more embodiments.

Referring to FIG. 5B, the wearable electronic device 201 may store 522 a touch sensor value related thereto when worn in a normal position 521. The wearable electronic device 201 may perform user calibration 523 based on the stored touch sensor value.

According to one or more embodiments, the wearable electronic device 201 may identify on which hand and which finger it is worn based on a touch sensor value obtained through the first sensor 512. For example, since a touch area by fingers adjacent to two opposite sides may be larger when worn on the middle finger compared to the ring finger, the wearing finger may be identified. Assuming that a user mainly wears the wearable electronic device 201 on the middle finger, a touch input based on fingers on two opposite sides of the middle finger may be detected within the specified range. If a touch sensor value is used in this way, customization may be possible for each user, and it may be possible to identify the user.

According to one or more embodiments, a wearable electronic device 101, 201 having a ring-shape may include at least one first sensor 512 configured to detect a touch input on the wearable electronic device, at least one second sensor 514 configured to detect a movement of the wearable electronic device, communication circuitry 590, memory 530, and a processor 520 operatively coupled to the at least one first sensor, the at least one second sensor, the communication circuitry, and/or the memory.

According to one or more embodiments, the memory may store instructions configured to, when executed, cause the wearable electronic device to detect a touch input through the first sensor.

According to one or more embodiments, the instructions may be configured to cause the wearable electronic device to, based on detecting the touch input, detect a signal representing a gesture using the at least one second sensor.

According to one or more embodiments, the instructions may be configured to cause the wearable electronic device to transmit information representing the gesture to an electronic device 502 communicatively connected to the wearable electronic device through the communication circuitry.

According to one or more embodiments, the instructions may be configured to cause the wearable electronic device to, based on detecting the touch input, identify whether a position where the touch input is detected is within a specified range from a reference position, and in response to identifying that the position where the touch input is detected is within the specified range, detect the signal representing the gesture using the at least one second sensor.

According to one or more embodiments, the instructions may be configured to cause the wearable electronic device to, in response to identifying that the position where the touch input is detected is outside the specified range, output a notification guiding an adjustment of a wearing position of the wearable electronic device.

According to one or more embodiments, the instructions may be configured to cause the wearable electronic device to, in response to identifying that the position where the touch input is detected is within the specified range from a reference position, output a notification guiding initiation of a gesture function of the wearable electronic device.

According to one or more embodiments, the instructions may be configured to cause the wearable electronic device to, based on the signal representing the gesture, identify a command for controlling an operation of the electronic device, and transmit the command for controlling the operation of the electronic device to the electronic device through the communication circuitry.

According to one or more embodiments, the instructions may be configured to cause the wearable electronic device to, based on detecting the touch input, identify whether the touch input within the specified range is maintained for a predetermined time, and in response to identifying that the touch input within the specified range is maintained for the predetermined time, detect the signal representing the gesture using the at least one second sensor.

According to one or more embodiments, the instructions may be configured to cause the wearable electronic device to, in response to identifying that the touch input within the specified range is maintained for the predetermined time after transmitting the information representing the gesture, terminate an operation of detecting the signal representing the gesture.

According to one or more embodiments, the at least one first sensor may include a first portion and a second portion spaced apart from the first portion by a predetermined distance, such that, when the wearable electronic device is worn on a first finger of a user, adjacent fingers on two opposite sides of the first finger come into contact with the first portion and the second portion.

According to one or more embodiments, the instructions may be configured to cause the wearable electronic device to detect a combination of touch inputs through the first portion and the second portion of the first sensor, and in response to detecting the combination of touch inputs, detect the signal representing the gesture using the at least one second sensor.

According to one or more embodiments, the at least one first sensor may include sensing circuitry connected to the first portion and the second portion of the first sensor.

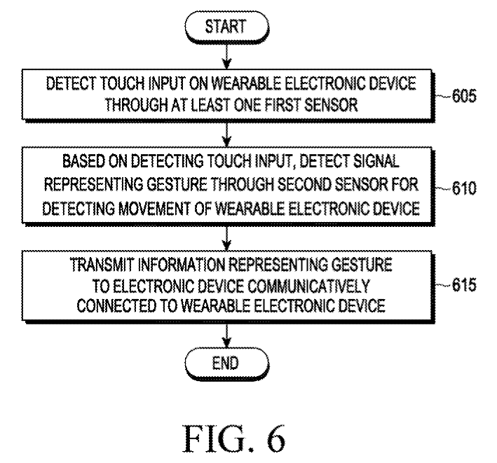

FIG. 6 is an operation flowchart for controlling an operation of an electronic device in a wearable electronic device according to one or more embodiments. Referring to FIG. 6, the operation method may include operations 605 to 615. Each operation of the operating method of FIG. 6 may be performed by at least one of a wearable electronic device (e.g., the electronic device 101 of FIG. 1 or the wearable electronic device 201 of FIGS. 2 to 5A) or at least one processor (e.g., the processor 120 of FIG. 1 or the processor 520 of FIG. 5) of the wearable electronic device. In one or more embodiments, at least one of operations 605 to 615 may be omitted or changed in order or may add other operations.

According to one or more embodiments, the wearable electronic device 201 having a ring-shape may, in operation 605, detect a touch input on the wearable electronic device through at least one first sensor 512 to control an operation of the electronic device 502.

According to one or more embodiments, the at least one first sensor may include a first portion and a second portion spaced apart from the first portion by a predetermined distance, such that, when the wearable electronic device is worn on a first finger of a user, adjacent fingers on two opposite sides of the first finger come into contact with the first portion and the second portion.

In operation 610, the wearable electronic device 201 may, based on detecting the touch input, detect a signal representing a gesture using the at least one second sensor 514 configured to detect a movement of the wearable electronic device. According to one or more embodiments, the wearable electronic device 201 may detect a combination of touch inputs through the first portion and the second portion of the first sensor. The wearable electronic device 201 may, in response to detecting the combination of touch inputs, detect the signal representing the gesture.

According to one or more embodiments, the wearable electronic device 201 may, based on detecting the touch input, identify whether a position where the touch input is detected is within a specified range from a reference position. The wearable electronic device 201 may, in response to identifying that the position where the touch input is detected is within the specified range, detect the signal representing the gesture.

According to one or more embodiments, the wearable electronic device 201 may, based on detecting the touch input, identify whether the touch input within the specified range is maintained for a predetermined time. The wearable electronic device 201 may, in response to identifying that the touch input within the specified range is maintained for the predetermined time, detect the signal representing the gesture.

According to one or more embodiments, the wearable electronic device 201 may, in response to identifying that the position where the touch input is detected is outside the specified range, output a notification guiding an adjustment of a wearing position of the wearable electronic device.

According to one or more embodiments, the wearable electronic device 201 may, in response to identifying that the position where the touch input is detected is within the specified range from a reference position, output a notification guiding initiation of a gesture function of the wearable electronic device.

In operation 615, the wearable electronic device 201 may, based on detecting the signal representing the gesture, transmit information representing the gesture to an electronic device communicatively connected to the wearable electronic device 201. For example, the wearable electronic device 201 may provide only the information representing the gesture to the electronic device, so that the electronic device may identify an operation to be controlled using the information representing the gesture.

According to one or more embodiments, the wearable electronic device 201 may, based on the signal representing the gesture, identify a command for controlling an operation of the electronic device. The wearable electronic device 201 may transmit the command for controlling the operation of the electronic device to the electronic device. For example, the wearable electronic device 201 may recognize (or analyze) the gesture and determine a command for controlling an operation of the electronic device mapped to (or corresponding to) the recognized gesture among configured control commands. The wearable electronic device 201 may provide the determined command to the electronic device. According to one or more embodiments, the wearable electronic device 201 may, after transmitting the information representing the gesture, in response to identifying that a touch input within the specified range is maintained for a predetermined time again, terminate an operation of detecting a signal representing a gesture.

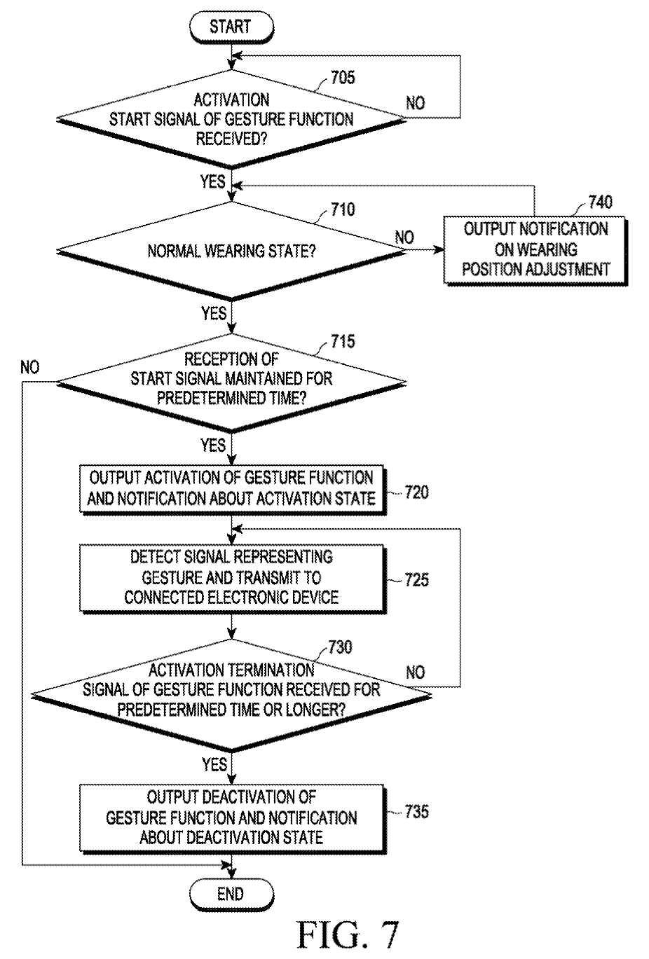

FIG. 7 is a detailed operation flowchart for controlling an operation of an electronic device using a gesture by a wearable electronic device according to one or more embodiments. Referring to FIG. 7, the operation method may include operations 705 to 740. Each operation of the operating method of FIG. 7 may be performed by at least one of a wearable electronic device (e.g., the electronic device 101 of FIG. 1 or the wearable electronic device 201 of FIGS. 2 to 5A) or at least one processor (e.g., the processor 120 of FIG. 1 or the processor 520 of FIG. 5) of the wearable electronic device. In one or more embodiments, at least one of operations 705 to 740 may be omitted or changed in order or may add other operations.

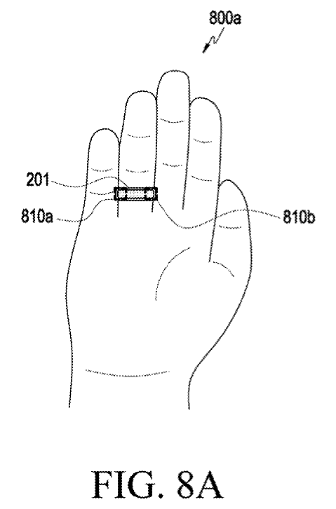

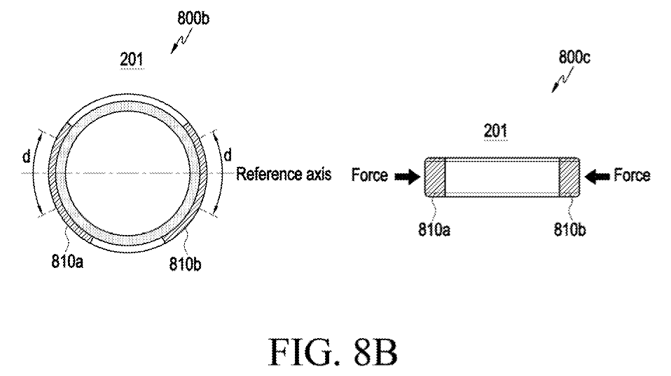

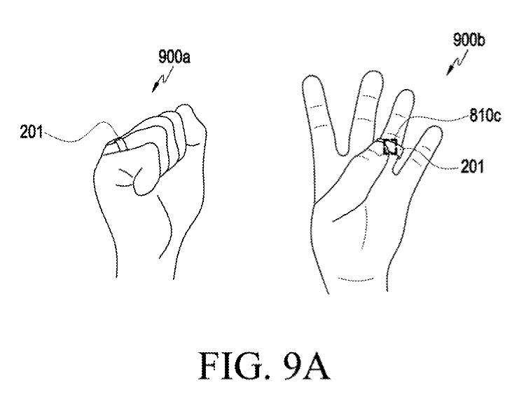

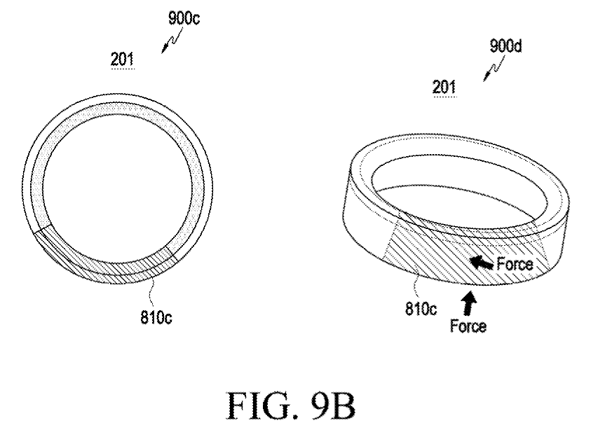

FIGS. 8A to 12 is referred to for understanding the description of FIG. 7. FIG. 8A is a view illustrating a wearing example of a wearable electronic device corresponding to a first gesture according to one or more embodiments, and FIG. 8B is a view illustrating a sensor arrangement for detecting a first gesture in a wearable electronic device according to one or more embodiments. FIG. 9A is a view illustrating a wearing example of a wearable electronic device corresponding to a second gesture according to one or more embodiments, and FIG. 9B is a view illustrating a sensor arrangement for detecting a second gesture in a wearable electronic device according to one or more embodiments.

According to one or more embodiments, in operation 705, the wearable electronic device 201 may identify whether an activation start signal of the gesture function is received.

Referring to FIGS. 8A and 8B, when the user wears the wearable electronic device 201 on a finger as illustrated in 800a, a touch input may be detected through portions 810a, 810b where a portion of a finger adjacent to two opposite sides of the wearing finger contacts. The first portion 810a and the second portion 810b may correspond to a position where fingers on two opposite sides adjacent to the wearing finger contact when the user wears the wearable electronic device 201 on a finger. For example, the first portion 810a (e.g., the first portion 476a of FIG. 4) and the second portion 810b (e.g., the second portion 476b of FIG. 4) may be formed in a specific shape, embossed, or engraved to guide the wearing position.

For example, when the user maintains a state of fingers attached together for a predetermined time as illustrated in 800a, a touch input may be detected through the first portion 810a and the second portion 810b as illustrated in 800b. As illustrated in 800c, when viewing the wearable electronic device 201 from a side, not only a touch input but also an input by pressure may be detected through the first portion 810a and the second portion 810b.

Referring to FIGS. 9A and 9B, while wearing the wearable electronic device 201, the user may make a fist as illustrated in 900a, or as illustrated in 900b, extend fingers and maintain a touch input to a third portion 810c (e.g., the third portion 476c of FIG. 4) of the wearable electronic device 201 corresponding to an inside of the finger with a thumb for a predetermined time. For example, when a fist state or a touch input with a thumb is maintained for a predetermined time, a touch input may be detected through the third portion 810c as illustrated in 900c. The third portion 810c of FIG. 9B may be a different portion from the first portion 810a and the second portion 810b of FIG. 8B. As illustrated in 900d, when viewing the wearable electronic device 201 from a side, not only a touch input but also an input by pressure may be detected through the third portion 810c.

As described above, when a touch input through the first portion 810a and the second portion 810b of FIGS. 8A and 8B is detected or a touch input through the third portion 810c of FIG. 9B is detected, the wearable electronic device 201 may determine that the touch input is received as a start signal for activation of the gesture function.

According to one or more embodiments, in response to identifying that the activation start signal of the gesture function is received, in operation 710, the wearable electronic device 201 may identify a normal wearing state. For example, each of the first portion 810a and the second portion 810b of FIG. 8B may contact fingers on two opposite sides within a specified range d based on a reference axis (or a reference position), and the wearable electronic device 201 may identify that it is a normal wearing state when a touch input is detected within the specified range d.

In response to identifying that it is not the normal wearing state, in operation 740, the wearable electronic device 201 may output guidance on wearing position adjustment. For example, the wearable electronic device 201 may output a notification inducing wearing. On the other hand, when a touch input is detected at a position outside the specified range d of FIG. 8B, it may be identified that it is not a normal wearing state.

In response to identifying the normal wearing state, in operation 715, the wearable electronic device 201 may identify whether the reception of the start signal is maintained for a predetermined time. For example, when the reception of the start signal is not maintained for a predetermined time, the wearable electronic device 201 may ignore the received start signal to terminate the operation for activation of the gesture function because it is not an input for activation of the gesture function. As another example, when the reception of the start signal is not maintained for a predetermined time, the wearable electronic device 201 may ignore the received start signal to perform operation 705 because it is not an input for activation of the gesture function.

On the other hand, in response to identifying that the reception of the start signal is maintained for a predetermined time, in operation 720, the wearable electronic device 201 may output activation of the gesture function and a notification about the activation state. When a touch input through the first portion 810a and the second portion 810b of FIGS. 8A and 8B is detected for a predetermined time or a touch input through the third portion 810c of FIG. 9B is detected for a predetermined time, it may be determined that the touch input is an intended input for activation of the gesture function. Accordingly, the wearable electronic device 201 may activate (or turn on) the gesture function. For example, the wearable electronic device 201 may generate a notification about the activation state of the gesture function. For example, when the wearable electronic device 201 includes a light emitting element (e.g., LED), it may generate a notification (e.g., light) corresponding to the activation state. For example, the wearable electronic device 201 may include a haptic module or a sound output module, and may generate a notification (e.g., sound or vibration) corresponding to the activation state. The wearable electronic device 201 may output the notification (e.g., light, sound, or vibration) corresponding to the activation state in a pattern specified by the user.

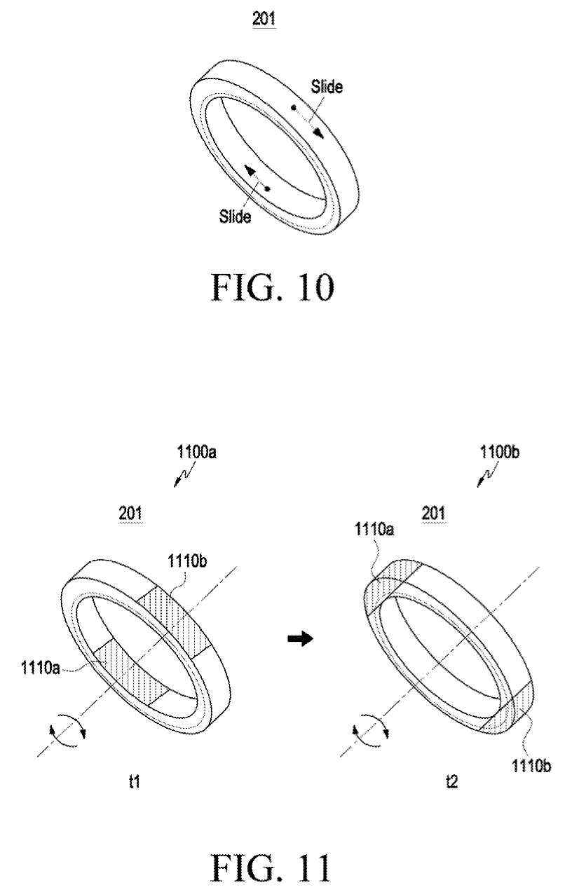

In operation 725, the wearable electronic device 201 may detect a signal representing a gesture and then transmit the signal to the connected electronic device 502. For example, the wearable electronic device 201 may, as illustrated in FIG. 10, provide information according to a touch input sliding on a surface of the wearable electronic device 201 to the electronic device 502. Here, FIG. 10 is a view illustrating a third gesture of a wearable electronic device for controlling an operation of an electronic device according to one or more embodiments. For example, the sliding touch input may be used to control a swipe operation of the electronic device 502, and the control operation is not limited thereto.

For example, the wearable electronic device 201 may, as illustrated in 1100a of FIG. 11, control a configured operation of the electronic device 502 according to a rotated angle (or amount of rotation) when the first portion 1110a and the second portion 1110b of the wearable electronic device 201 rotate 90 degrees at time t2 from time t1. For example, rotation of a rotation axis may serve as a wheel of an electronic device 502 such as a smart watch. Here, FIG. 11 is a view illustrating a fourth gesture of a wearable electronic device for controlling an operation of an electronic device according to one or more embodiments.

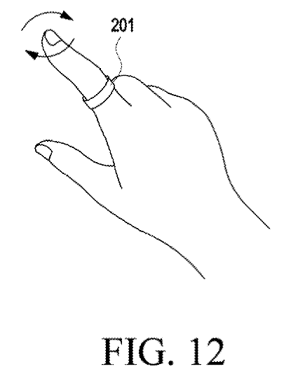

FIG. 12 is a view illustrating a fifth gesture of a wearable electronic device for controlling an operation of an electronic device according to one or more embodiments. As illustrated in FIG. 12, a gesture such as a motion of rotating a finger while the user wears the wearable electronic device 201 may also be used as a command for controlling an operation of the electronic device 502.

While the gesture function is activated, in operation 730, the wearable electronic device 201 may identify whether an activation termination signal of the gesture function is received for a predetermined time or longer. For example, when the activation termination signal of the gesture function is not received for a predetermined time or longer, the wearable electronic device 201 may return to operation 725 to perform an operation of detecting a signal representing a gesture. For example, the wearable electronic device 201 may maintain the activation state of the gesture function unless a signal for terminating the gesture function is received.

When the activation termination signal of the gesture function is received for a predetermined time or longer, in operation 735, the wearable electronic device 201 may output deactivation of the gesture function and a notification about the deactivation state. When a touch input through the first portion 810a and the second portion 810b of FIGS. 8A and 8B is detected for a predetermined time or a touch input through the third portion 810c of FIG. 9B is detected for a predetermined time, it may be determined that the touch input is an intended input for deactivation of the gesture function. As such, when a touch input is detected again for a predetermined time in a state in which the gesture function is activated, it may be determined that the touch input is an intended input for deactivation of the gesture function. As such, a signal for terminating the gesture function may be similar to or the same as a signal for activation of the gesture function, but the type thereof may not be limited thereto. For example, when a signal for activation of the gesture function is a first type signal (e.g., a touch input by fingers on two opposite sides as in FIG. 8A), a signal for deactivation of the gesture function may be a second type signal (e.g., a method of making a fist as in FIG. 9A, or a method of touching with one finger).

The wearable electronic device 201 may deactivate (or turn off) the gesture function by stopping an operation of a sensor for identifying the gesture function, and may output a notification about the deactivation state. For example, the user may identify through the notification about the deactivation state that the gesture function of the wearable electronic device 201 has been terminated.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store^{TM}), or between two user devices (e.g., smartphones) directly. If distributed online, at least part of the computer program product may be temporarily generated or at least temporarily stored in the machine-readable storage medium, such as memory of the manufacturer’s server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

Terms such as “comprising,” “having,” “including,” and “containing” are to be construed as open-ended (meaning “including, but not limited to”) unless otherwise noted. These terms specify the presence of stated features, numbers, steps, operations, elements, components, or combinations thereof, but do not preclude the presence or addition of other features, numbers, steps, operations, elements, components, or combinations thereof.

Further, unless stated otherwise or otherwise clear from context, phrase “based on” may refer to “based at least in part on” and not “based solely on.”

According to one or more embodiments, in a non-transitory storage medium (e.g., computer-readable, machine-readable) storing instructions, the instructions are configured to, when executed by at least one processor 120, 520 of a wearable electronic device 101, 201, cause the wearable electronic device to perform at least one operation, and the at least one operation may include detecting a touch input on the wearable electronic device through at least one first sensor 512.

According to one or more embodiments, the at least one operation may include, based on detecting the touch input, detecting a signal representing a gesture using at least one second sensor 514 configured to detect a movement of the wearable electronic device.

According to one or more embodiments, the at least one operation may include transmitting information representing the gesture to an electronic device communicatively connected to the wearable electronic device.

What is claimed is:

1. A wearable electronic device having a ring-shape, the wearable electronic device comprising:
at least one first sensor configured to detect a touch input on the wearable electronic device;
at least one second sensor configured to detect a movement of the wearable electronic device;
communication circuitry;
memory storing instructions; and
at least one processor operatively coupled to the at least one first sensor, the at least one second sensor, the communication circuitry, and the memory,
wherein the instructions, when executed by the at least one processor individually or collectively, cause the wearable electronic device to:
detect the touch input using the at least one first sensor;
based on detecting the touch input, detect a signal representing a gesture using the at least one second sensor; and
transmit information representing the gesture to an electronic device communicatively connected to the wearable electronic device using the communication circuitry.

2. The wearable electronic device of claim 1, wherein the instructions, when executed by the at least one processor individually or collectively, further cause the wearable electronic device to:
based on detecting the touch input, identify whether a position where the touch input is detected is within a specified range from a reference position; and
based on identifying that the position where the touch input is detected is within the specified range, detect the signal representing the gesture using the at least one second sensor.

3. The wearable electronic device of claim 2, wherein the instructions, when executed by the at least one processor individually or collectively, further cause the wearable electronic device to:
based on identifying that the position where the touch input is detected is outside the specified range, output a notification guiding an adjustment of a wearing position of the wearable electronic device.

4. The wearable electronic device of claim 2, wherein the instructions, when executed by the at least one processor individually or collectively, further cause the wearable electronic device to:
based on identifying that the position where the touch input is detected is within the specified range, output a notification guiding initiation of a gesture function of the wearable electronic device.

5. The wearable electronic device of claim 1, wherein the instructions, when executed by the at least one processor individually or collectively, further cause the wearable electronic device to:
based on the signal representing the gesture, identify a command for controlling an operation of the electronic device; and
transmit the command for controlling the operation of the electronic device to the electronic device using the communication circuitry.

6. The wearable electronic device of claim 1, wherein the instructions, when executed by the at least one processor individually or collectively, further cause the wearable electronic device to:
based on detecting the touch input, identify whether the touch input within a specified range from a reference position is maintained for a predetermined time;
based on identifying that the touch input within the specified range is maintained for the predetermined time, detect the signal representing the gesture using the at least one second sensor; and
based on identifying that the touch input within the specified range is maintained for the predetermined time after transmitting the information representing the gesture, terminate an operation of detecting the signal representing the gesture.

7. The wearable electronic device of claim 1, wherein the at least one first sensor comprises a first part and a second part spaced apart from the first part by a predetermined distance, and
wherein adjacent fingers on both sides of a first finger of a user come into contact with the first part and the second part based on the wearable electronic device being worn on the first finger.

8. The wearable electronic device of claim 7, wherein the instructions, when executed by the at least one processor individually or collectively, further cause the wearable electronic device to:
detect a combination of touch inputs using the first part and the second part of the at least one first sensor; and
based on detecting the combination of touch inputs, detect the signal representing the gesture using the at least one second sensor.

9. The wearable electronic device of claim 7, wherein the at least one first sensor comprises sensing circuitry connected to the first part and the second part of the at least one first sensor.

10. A method for controlling an operation of an electronic device from a wearable electronic device having a ring-shape, the method comprising:
detecting a touch input on the wearable electronic device using at least one first sensor;
based on detecting the touch input, detecting a signal representing a gesture using at least one second sensor configured to detect a movement of the wearable electronic device; and
transmitting information representing the gesture to the electronic device.

11. The method of claim 10, wherein detecting the signal representing the gesture comprises:
based on detecting the touch input, identifying whether a position where the touch input is detected is within a specified range from a reference position; and
based on identifying that the position where the touch input is detected is within the specified range, detecting the signal representing the gesture.

12. The method of claim 11, further comprising:
based on identifying that the position where the touch input is detected is outside the specified range, outputting a notification guiding an adjustment of a wearing position of the wearable electronic device.

13. The method of claim 11, further comprising:
based on identifying that the position where the touch input is detected is within the specific range, outputting a notification guiding initiation of a gesture function of the wearable electronic device.

14. The method of claim 10, further comprising:
based on the signal representing the gesture, identifying a command for controlling the operation of the electronic device; and
transmitting the command for controlling the operation of the electronic device to the electronic device.

15. A non-transitory computer-readable storage medium having stored thereon instructions that, when executed by at least one processor of a wearable electronic device, cause the wearable electronic device to:
detect a touch input on the wearable electronic device using at least one first sensor;
based on detecting the touch input, detect a signal representing a gesture using at least one second sensor configured to detect a movement of the wearable electronic device; and
transmit information representing the gesture to an electronic device communicatively connected to the wearable electronic device.

16. The non-transitory computer-readable storage medium of claim 15, wherein the instructions, when executed by the at least one processor of the display device, further cause the wearable electronic device to:
based on detecting the touch input, identify whether a position where the touch input is detected is within a specified range from a reference position; and
based on identifying that the position where the touch input is detected is within the specified range, detect the signal representing the gesture using the at least one second sensor.

17. The non-transitory computer-readable storage medium of claim 16, wherein the instructions, when executed by the at least one processor of the display device, further cause the wearable electronic device to:
based on identifying that the position where the touch input is detected is outside the specified range, output a notification guiding an adjustment of a wearing position of the wearable electronic device.

18. The non-transitory computer-readable storage medium of claim 16, wherein the instructions, when executed by the at least one processor of the display device, further cause the wearable electronic device to:
based on identifying that the position where the touch input is detected is within the specified range, output a notification guiding initiation of a gesture function of the wearable electronic device.

19. The non-transitory computer-readable storage medium of claim 15, wherein the instructions, when executed by the at least one processor of the display device, further cause the wearable electronic device to:
based on the signal representing the gesture, identify a command for controlling an operation of the electronic device; and
transmit the command for controlling the operation of the electronic device to the electronic device using the communication circuitry.

20. The non-transitory computer-readable storage medium of claim 15, wherein the instructions, when executed by the at least one processor of the display device, further cause the wearable electronic device to:
based on detecting the touch input, identify whether the touch input within a specified range from a reference position is maintained for a predetermined time;
based on identifying that the touch input within the specified range is maintained for the predetermined time, detect the signal representing the gesture using the at least one second sensor; and
based on identifying that the touch input within the specified range is maintained for the predetermined time after transmitting the information representing the gesture, terminate an operation of detecting the signal representing the gesture.
